(19) United States
(12) Patent Application Publication
(10) Pub. No.: US 2017/0070379 A1
(43) Pub. Date: Mar. 9, 2017

(54) METHOD AND APPARATUS FOR INDOOR DEVICE MANAGEMENT

(71) Applicant: SAMSUNG ELECTRONICS CO., LTD., Suwon-si (KR)

(72) Inventors: Junhyung KIM, Yongin-si (KR); Deepraj Prabhakar PATKAR, Bangalore (IN); Dongkeon KONG, Suwon-si (KR)

(21) Appl. No.: 15/259,382

(22) Filed: Sep. 8, 2016

(30) Foreign Application Priority Data
Sep. 8, 2015 (KR) 10-2015-0126992

(51) Int. Cl. H04L 12/24; H04L 12/26

(52) U.S. Cl. CPC H04L 41/044; H04L 41/24; H04L 43/10; H04L 41/048

(57) ABSTRACT

The present disclosure may relate, for example, to a method for managing an indoor device and, more particularly, to a method and a device for managing an indoor device on the basis of state information of at least one indoor device located in a certain space. A method for managing indoor information in a terminal according to an embodiment of the present disclosure comprises: determining at least one device to request device state information based on basic device information received from at least one device; requesting the determined at least one device for device state information; and transmitting the device state information to a management server from the determined at least one device. The basic device information is transmitted if the terminal coming indoors is detected.

The present disclosure may relate, for example, to technologies of sensor network, M2M (Machine to Machine), MTC (Machine Type Communication), and IoT (Internet of Things). The present disclosure may be used, for example, for intelligent services such as a smart home, smart building, smart city, smart car or connected car, health care, digital education, retail business, and security service, on the basis of the technologies.

### CROSS-REFERENCE TO RELATED APPLICATION

This application is based on and claims priority under 35 U.S.C. §119 to Korean Patent Application No. 10-2015-0126992 filed in the Korean Intellectual Property Office on Sep. 8, 2015, the disclosure of which is incorporated by reference herein in its entirety.

### TECHNICAL FIELD

The disclosure relates to a method for managing an indoor device and, for example, to a method and a device for managing an indoor device on the basis of state information of at least one indoor device located in a certain space.

### BACKGROUND

The Internet is progressing from an anthropic connection network generating and consuming human-oriented information to an IoT (Internet of Things) network exchanging and processing information between distributed components. The IoE (Internet of Everything) technology combining an IoT technology and a big data processing technology through connection with a cloud server is being introduced. In order to realize the IoT, technical factors such as a sensor technology, wired/wireless communication and network infrastructure, service interface technology, and security technology are required. Therefore technologies for connecting between things such as a sensor network, M2M (Machine to Machine), and MTC (Machine Type Communication) are being developed.

In the IoT environment, an intelligent IT (Internet Technology) service can be provided to create new values for a human life by collecting and analyzing data generated from connected things. The IoT technology can be applied to a smart home, smart building, smart city, smart car or connected car, smart grid, health care, smart home appliances, and advanced medical service by combining or integrating the existing IT(information technology) technology with various industrial technologies.

According to the conventional technologies, persons must manually identify operation states of each device to manage a plurality of devices located in a certain indoor space. Particularly in the case of a hotel, staffs may experience inconveniences because they must spend much time to check conditions of devices installed in rooms continuously through the days. These problems may also be generated similarly at offices, practical rooms of schools, and educational places. Therefore a method for solving the problems is necessary.

### SUMMARY

The disclosure addresses the above identified problems. For example, the disclosure provides a method and a device for managing an indoor device so that a portable terminal of a manager can collect device state information from at least one indoor device and transmit the information to a management server. Further, the disclosure provides a method that indoor information collecting equipment collects device state information of indoor devices from communication equipment attached to at least one indoor device and transmits the information to a management server.

A method for managing indoor information in a terminal according to an example embodiment comprises: determining at least one device from which to request device state information based on basic device information received from at least one device; requesting device state information from the determined at least one device; and transmitting the device state information from the determined at least one device to a management server. The basic device information is transmitted if the terminal coming indoors is detected.

Further, a method for managing indoor device information in information collecting equipment according to another example embodiment comprises: determining at least one device from which to request device state information based on basic device information received from communication equipment attached to at least one device; requesting device state information from the communication equipment attached to the determined at least one device; and transmitting the device state information from the communication equipment attached to the determined at least one device to a management server .

Further, a method for supporting device information management in an indoor device according to another example embodiment comprises: transmitting basic device information to a terminal if the terminal coming indoors is detected; and transmitting the device state information to the terminal if a request for device state information is received from the terminal. The device state information is transmitted to a management server from the terminal.

Further, a method for supporting device information management in a communication equipment attached to an indoor device according to another example embodiment comprises: transmitting basic device information to information collecting equipment; generating the device state information if a request for device state information is received from the information collecting equipment; and transmitting the device state information to the information collecting equipment. The device state information is transmitted to a management server from a terminal.

Further, a terminal for managing indoor device information according to another example embodiment comprises: a transceiver configured to transmit and receive information; and a controller configured to determine at least one device from which to request device state information based on basic device information received from the at least one device, to request device state information from the determined at least one device, and to transmit the device state information from the determined at least one device to a management server. The basic device information is transmitted if the terminal coming indoors is detected.

Further, an information collecting equipment for managing indoor device information according to another example embodiment comprises: a transceiver configured to transmit and receive information; and a controller configured to determine at least one device from which to request device state information based on basic device information received from a communication equipment attached to the at least one device, to request device state information from the communication equipment attached to the determined at least one device, and to transmit the device state information from the communication equipment to a management server.

Further, an indoor device for supporting a device information management according to another example embodiment comprises: a transceiver configured to transmit and receive information; and a controller configured to transmit basic device information to a terminal if the terminal coming indoors is detected, to transmit device state information to the terminal if a request for the device state information is received from the terminal, and to transmit the device state information to a management server from the terminal.

Further, a communication equipment attached to an indoor device for supporting device information management according to another example embodiment comprises: a transceiver configured to transmit and receive information; and a controller configured to transmit basic device information to information collecting equipment, to generate the device state information if a request for device state information is received from the information collecting equipment, to transmit the device state information to the information collecting equipment, and to transmit the device state information to a management server from a terminal.

### BRIEF DESCRIPTION OF THE DRAWINGS

The above and other aspects, features, and advantages of certain example embodiments will be more apparent from the following detailed description, taken in conjunction with the accompanying drawings, in which like reference numerals refer to like elements, and wherein:

FIG. 1 is a block diagram illustrating an example configuration of a system for managing indoor device information according to an example embodiment.

FIG. 2 is a schematic drawing illustrating an example method for collecting indoor device information according to an example embodiment.

FIG. 3 is a schematic drawing illustrating an example method for collecting indoor device information according to another example embodiment.

FIGS. 4A, 4B, and 4C are flowcharts illustrating an example method of collecting device information according to an example embodiment.

FIGS. 5A, 5B, 5C, and 5D are diagrams illustrating an example configuration of a basic device information notification message according to an example embodiment.

FIGS. 6A, 6B, and 6C are diagrams illustrating an example configuration of a device state information notification message according to an example embodiment.

FIGS. 7A and 7B are flowcharts illustrating example operations of a device according to an example embodiment.

FIG. 8 is a schematic drawing illustrating example communication equipment attached to a device according to an example embodiment.

FIG. 9 is a schematic drawing illustrating an example hub device connected to a communication equipment attached to a device for collecting location information of the communication equipment according to an example embodiment.

FIG. 10 is a block diagram illustrating an example internal configuration of device information collecting equipment according to an example embodiment.

FIG. 11 is a block diagram illustrating an example internal configuration of communication equipment attached to a device according to another example embodiment.

FIG. 12 is a block diagram illustrating an example internal configuration of a device according to another example embodiment.

### DETAILED DESCRIPTION

Hereinafter, example embodiments are described in greater detail with reference to the accompanying drawings. Detailed descriptions of well-known functions and structures incorporated herein may be omitted to avoid obscuring the subject matter of the disclosure.

For the same reasons, some components in the accompanying drawings are emphasized, omitted, or schematically illustrated, and the size of each component does not fully reflect the actual size. The same reference symbols are used throughout the drawings to refer to the same or like parts.

Advantages and characteristics of the present disclosure and a method for achieving them will become apparent with reference to the accompanying drawings and example embodiments described hereinafter. However the present disclosure is not limited to the example embodiments disclosed hereinafter and can be implemented in various forms. The terms and words used in the following description and claims are not limited to the bibliographical meanings, but, are merely used by the inventor to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents. The same reference symbols are assigned to the identical components throughout the disclosure.

Here, it should be understood that each block of a flowchart and combinations of flowcharts can be implemented by executing computer program instructions. The computer program instructions can be launched on a general-purpose computer, special computer, or processor of programmable data processing equipment, and thereby the instructions executed by a computer or a processor of programmable data processing equipment can perform functions described in the flowchart block(s). The computer program instructions can be stored in a computer-usable or computer-readable memory of a computer or other computer-programmable data processing equipment to perform a function in a specific method, and thereby the instructions stored in the computer-usable or computer-readable memory enable to produce manufacture articles including instructions for performing functions described in the flowchart block(s). The computer program instructions can be launched on a computer or other programmable data processing equipment, and thereby the instructions operating the computer or other programmable data processing equipment can provide steps for executing functions described in the flowchart block(s) by performing a series of operations in the computer or other programmable data processing equipment and generating a process to be performed by the computer.

Further, each block may indicate a module, segment, or portion of a code including one or more executable instructions to perform a specific logical function(s). It should be understood that the functions described in the blocks can be performed in different orders in some replaceable execution examples. For example, adjacent two blocks can be performed at the same time practically or the blocks can be performed sometimes in a reverse order corresponding to a function.

Hereinafter, the term “unit” used in the embodiments of the present disclosure may refer, for example, to software or hardware components such as various processing circuitry (e.g., a CPU, controller, processor, or the like), a FPGA and an ASIC, and the “unit” performs certain roles. However it does not mean that the “unit” is limited to the software or hardware components. The “unit” may be configured to exist in an addressable storage medium or to operate one or more processors. Accordingly, the “unit” may include software components such as object-oriented software components, class components, task components, processes, functions, attributes, procedures, subroutines, segments of program code, drivers, firmware, microcode, circuits, data, database, data structures, tables, arrays, and variables. Functions provided in the components and the “units” can be combined to functions having a smaller number of components or divided into additional components and “units”. Further, the components and the “units” can be configured to operate one or more CPUs installed in a device or a security multimedia card.

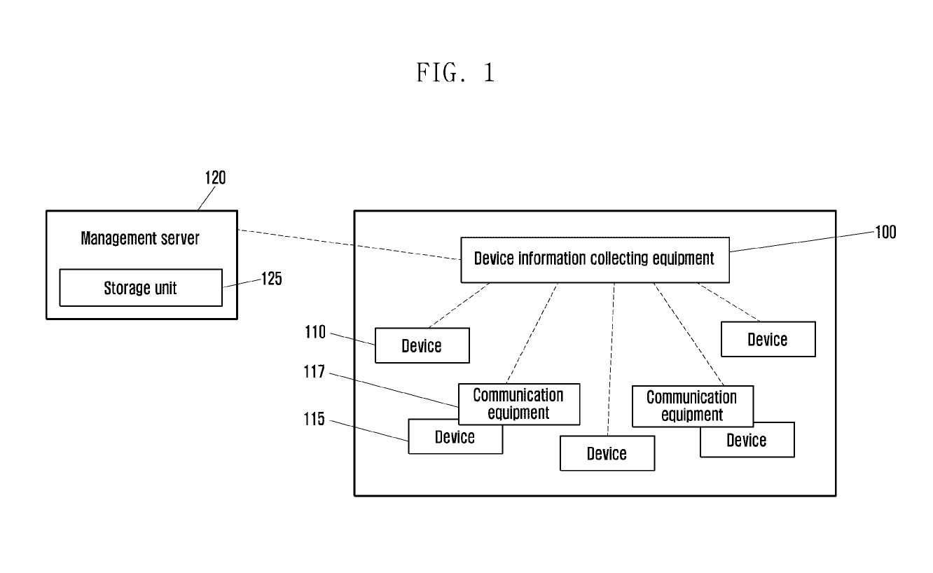

FIG. 1 is a block diagram illustrating an example configuration of a system for managing indoor device information according to an example embodiment.

With reference to FIG. 1, the system for managing the indoor device information may include a device information collecting equipment 100, devices 110 and 115, communication equipment 117 attached to the device, and management server 120 connected to the device information collecting equipment 100 in an indoor space. Further, the device information collecting equipment 100 may include at least one of a gateway, portable device, and hub device. The management server 120 may further include a storage unit 125.

The “indoor” may refer, for example, to “inside a specific place” such as inside an office, inside a warehouse, inside a house, or inside a hotel. In the present disclosure, a hotel is assumed as an example for the convenience in description, however the scope of the present disclosure is not limited to this example.

The device information collecting equipment 100 may refer, for example, to equipment for collecting information of a plurality of devices located in an indoor place. The information of device may include detailed information of device, and the “device state information” can be used to identify the current state of device from variable states of device. For example, the “device state information” may include a setting state determined by a manager, battery capacity, memory usage, maintenance necessity, compensation necessity, and history information. The device information collecting equipment 100 can collect and transmit device sate information of indoor devices to the management server 120. Subsequently, the devices can be managed on the basis of the device state information transmitted to the management server 120.

The device information collecting equipment 100 may be at least one of a gateway and a portable device. A plurality of device information collecting equipment 100 may exist in an indoor place, and least two of the gateways and the portable devices may exist at the same time. The device information collecting equipment 100 using a gateway and a portable device according to an embodiment of the present disclosure will be described later. The gateway may be a separate device and include a device integrated into home appliances existing in an indoor place and connected to a management server. Further, the portable device may be a portable device generally being used.

The device information collecting equipment 100 can be connected to a plurality of devices 110 and 115 using, for example, a WLAN (Wireless Local Area Network) communication. The WLAN communication may include Bluetooth, WiFi, WiFi-Direct, Zigbee, or NFC. In the present disclosure, Bluetooth is assumed to be a WLAN communication for the convenience in description, however the scope of the present disclosure is not limited to these example.

The management server 120 can store device state information in a storage unit 125 by receiving from the device information collecting equipment 100. The management server 120 can store the device state information in the storage unit by converting to a predetermined data format. The device state information stored in the storage unit of the management server 120 can be used to manage devices by monitoring the devices in real time. For example, a hotel manager can identify device state information in real time from a server if necessary, or if an abnormal state of device is detected through the device state information in the management server 120, the management server 120 can transmit a notification message to a hotel manager's portable terminal or a management computer.

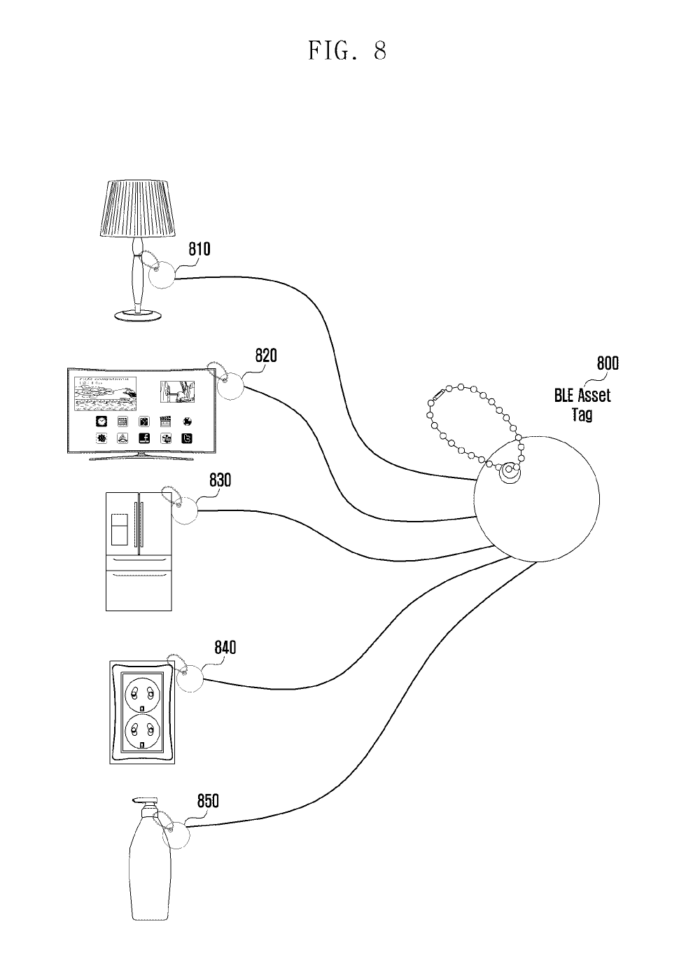

The plurality of indoor devices 110 and 115 may be divided into a device 110 including a communication module for connecting with the device information collecting equipment 100 through WLAN communication and a device 115 not including a communication module. The device 110 including a communication module can transmit and receive a message directly by connecting to the device information collecting equipment 110, however the device 115 can also attach a communication equipment 117 in a detachable type in order to communicate with the device information collecting equipment 100. For example, the communication equipment 117 may include a Bluetooth tag. The communication equipment 117 may be equipment having a small form factor which can be easily attached to any type of devices. The communication equipment 117 can provide information such as existence of a device, movement detection, or fall down state. Further, location information of the device 115 can be obtained by using the communication equipment 117. Detailed description on this will be made with reference to FIG. 8.

A method for collecting device information from devices by the device information collecting equipment 100 according to the present disclosure may be divided into the following two example methods.

First method: using a gateway separately installed in an indoor space as a device information collecting equipment.

Second method: using a portable device as a device information collecting equipment.

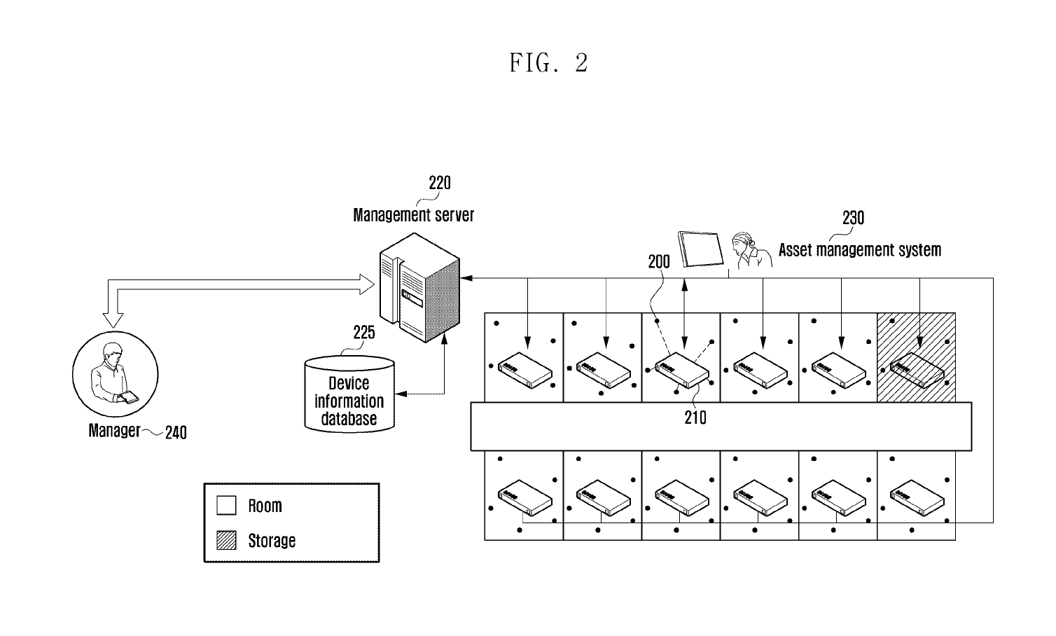

FIG. 2 is a schematic drawing illustrating an example method for collecting indoor device information according to an embodiment.

FIG. 2 relates to the first method which illustrates a method for managing device information in hotel rooms. The hotel may include a space required to manage devices in a certain area of the hotel such as a storage room as well as guest rooms. The guest room may include a plurality of devices 200 and gateways 210 used as device information collecting equipment. Further, the gateways 210 can transmit collected device information to a management server 220 and an asset management system 230 by connecting through a wired LAN, and the management server 220 can transmit the result of analyzing the received device information to a manager 240. For example, if an abnormal state of device is detected on the basis of the device information collected by the management server 220, the manager 240 can take an action by receiving a notification. The management server 220 and the manager 240 can be connected through wireless communication.

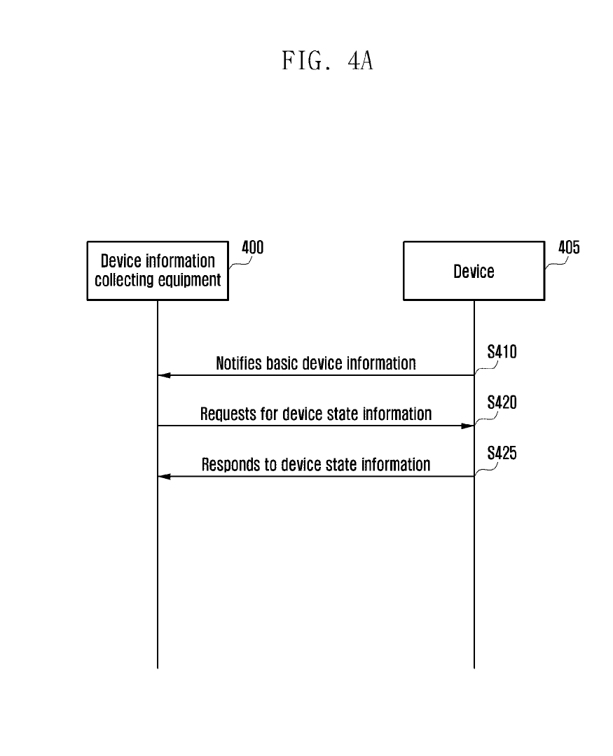

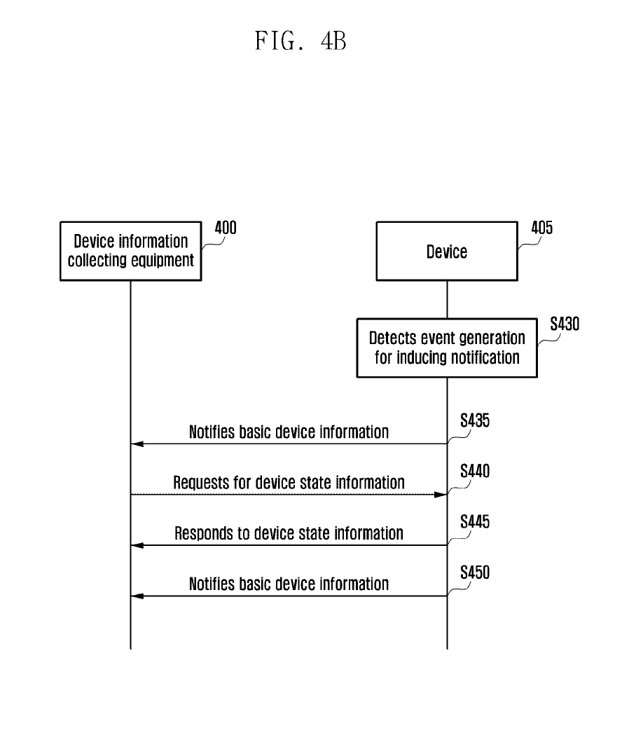

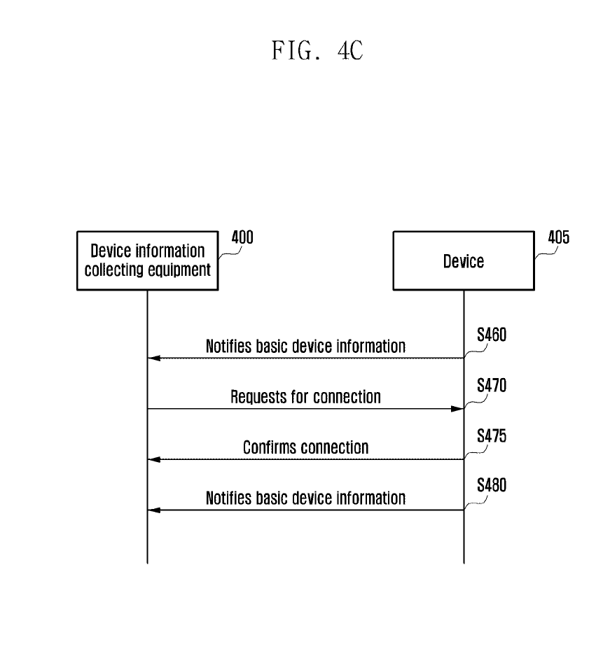

The devices 200 in the guest room can transmit basic device information of themselves periodically to the gateway 210 located in the guest room through WLAN communication such as a Bluetooth. Further, the period of transmission can be adjusted through a connection between the gateway 210 and the plurality of devices 200. Alternatively, the devices 200 in the guest room can transmit basic device information if a specific event is generated which is necessary to report detailed device information of themselves. The gateway 210 received the report can request transmission of device state information. A method and a procedure for transmitting information between the devices 200 and the gateway 210 in the guest room will be described in more detail with reference to FIG. 4.

As described above, transmission of device state information can be requested responding to a reception of basic device information, or the gateway can request the devices in the guest room for device state information in a specific period as another embodiment of the present disclosure.

After collecting device state information from the devices, the gateway 210 can transmit the device state information to the management server 220. Further, the gateway 210 can transmit the device state information to an external cloud server (not shown). The device state information is transmitted to the external cloud server and shared between hotels connected in a chain. Namely, the device state information can be accumulated to generate characteristic information of each device and used for managing the devices.

The device state information transmitted to the management server 220 can be stored in a device information database 225 by converting to a predefined data format. Further, the stored device state information can be monitored in real time by using the asset management system 230. For example, the device state information can be monitored according to the present installation of devices in each guest room and the predefined data format. The method for monitoring device state information is out of the scope of the present disclosure, and thereby detailed description on this method will be omitted.

Further, the management server 220 can transmit device state information of each guest room to the manager 240 through a wireless connection. Alternatively, the manager 240 can request the management server 220 for the device state information. The management server 220 can detect an abnormal state of a device from the received device state information if some factors of the device state information become greater or less than a predetermined critical value and inform the abnormal state to the asset management system 230 or the manager 240.

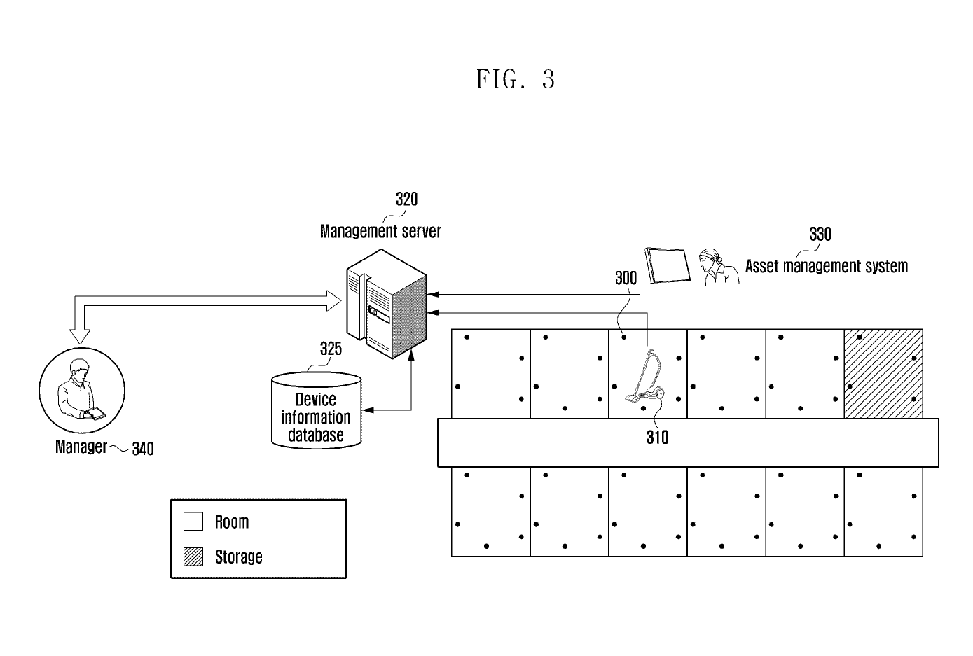

FIG. 3 is a schematic drawing illustrating an example method for collecting indoor device information according to another embodiment.

FIG. 3 relates to the second method which illustrates a method for managing device information in hotel rooms. Differently from the first method, the second method corresponds to a case that a separate gateway is not installed in a guest room and a portable device takes a role of a gateway. Without installing a separate gateway in the guest room, a manager 340 or a housekeeper can take an advantage of collecting state information of a plurality of devices 300 while staying in a guest room.

In order to collect device information of the plurality of devices 300, the portable device 310 is assumed to include a WLAN communication module. For example, the portable device 310 may include a vacuum cleaner or a portable terminal. In the meantime, the portable device 310 can connect to the management server 320 through a wireless connection. The method for transmitting and receiving information between the management server 320, device information database 325, asset management system 330, and manager 340 is identical to the method shown in FIG. 2.

If the portable device 310 comes into a guest room, a plurality of devices 300 in the guest room can detect the portable device 310 and transmit basic device information of themselves to the portable device 310 through WLAN communication such as a Bluetooth. Besides detecting the portable device 310 by the plurality of devices 300, if a manager or a cleaner holding a portable terminal enters a door, a sensor attached to a door lock can recognize the entrance of the portable device 310. The door lock can transmit a request signal so that assets installed in the guest room can transmit basic device information. Alternatively, an AP (Access Point) in a hotel can detect the portable device 300 and let the assets in the guest room transmit a state information message. Alternatively, if cleaning time of a guest room is predetermined through a connection between the portable device 310 and the plurality of devices 300, the assets installed in the guest room can transmit a state information message automatically. Besides these, other methods for detecting the entrance of the portable device 310 into a guest room can be included in the present disclosure.

Subsequently, the portable device 310 received the basic device information can request transmission of the device state information. A method and a procedure for transmitting information between the devices 300 in the guest room and the portable device 310 will be described in more detail with reference to FIG. 4.

While the portable device 310 is staying in the guest room, whole the device state information in the guest room is collected by the portable device 310. Subsequently, the portable device 310 can transmit the collected device state information to the management server 320 or an external cloud server (not shown). If the device state information is transmitted to the external cloud server, the information can be shared between the hotels connected through a chain. Namely, the device state information can be accumulated to generate characteristic information of each device and used for managing the devices.

The device state information transmitted to the management server 320 can be stored in the device information database 325 by converting to a predefined data format. Further, the stored device state information can be monitored in real time by using the asset management system 330. For example, the device state information can be monitored according to the present installation of devices in each guest room and the predefined data format. The method for monitoring device state information is out of the scope of the present disclosure, and thereby detailed description on this method will be omitted.

Further, the management server 320 can transmit device state information of each guest room to the manager 340 through a wireless connection. Alternatively, the manager 340 can request the management server 320 for the device state information. The management server 320 can detect an abnormal state of a device from the received device state information if some factors of the device state information become greater or less than a predetermined critical value and inform the abnormal state to the asset management system 330 or the manager 340.

FIGS. 4A, 4B, and 4C are flowcharts illustrating an example method for collecting device information according to an example embodiment of the present disclosure.

In more detail, FIGS. 4A, 4B, and 4C illustrate a procedure of collecting information of device 405 by a device information collecting equipment 400, and the device information collecting equipment 400 may include a gateway and a portable device previously described. The device 405 can transmit basic device information so that the device information collecting equipment 400 can identify the existence of the device 405. FIGS. 4A, 4B, and 4C are drawings illustrating a detailed embodiment of the method for transmitting basic device information by the device 405.

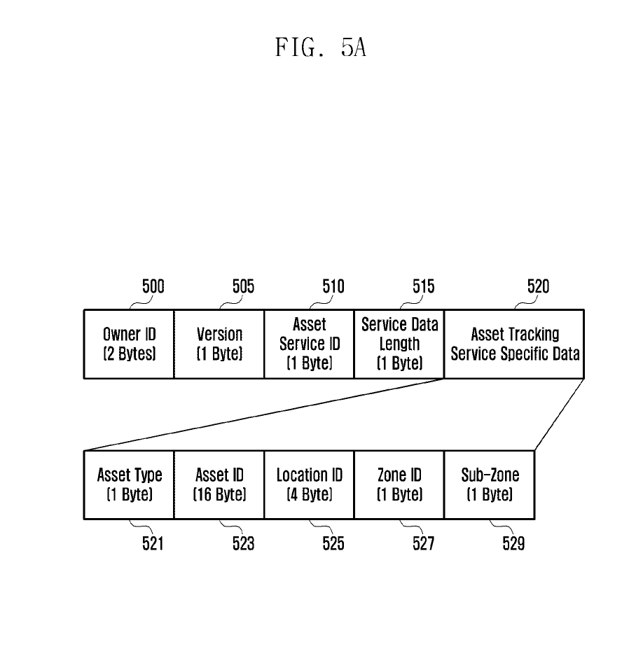

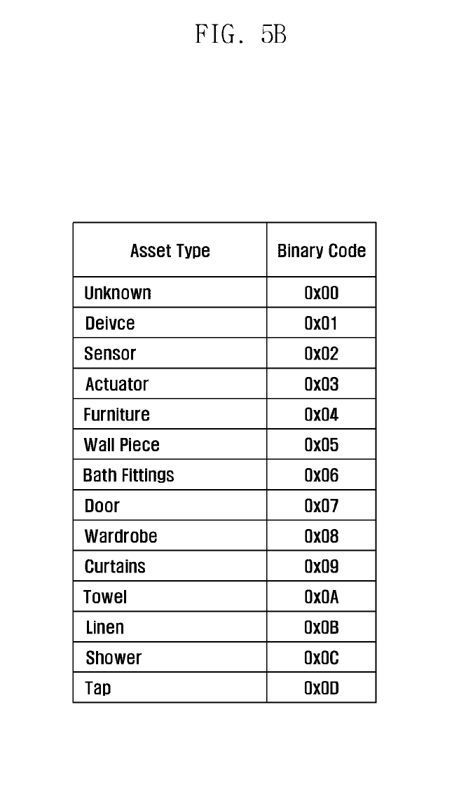

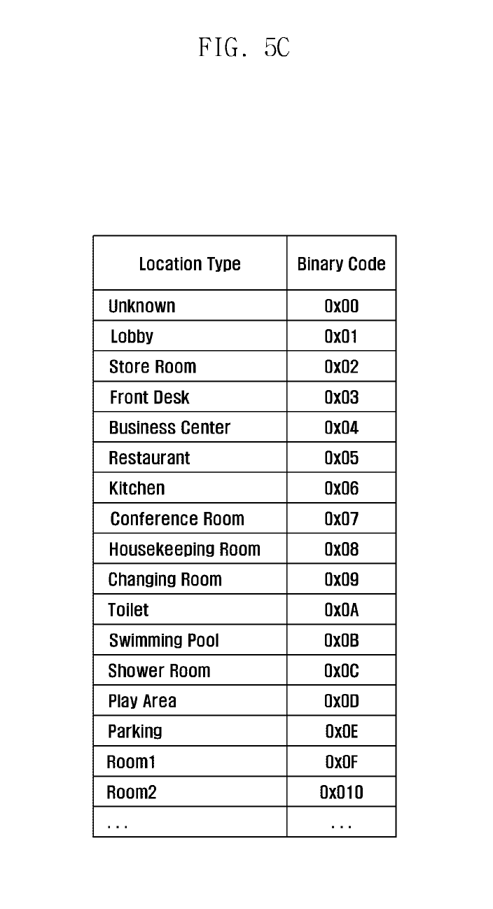

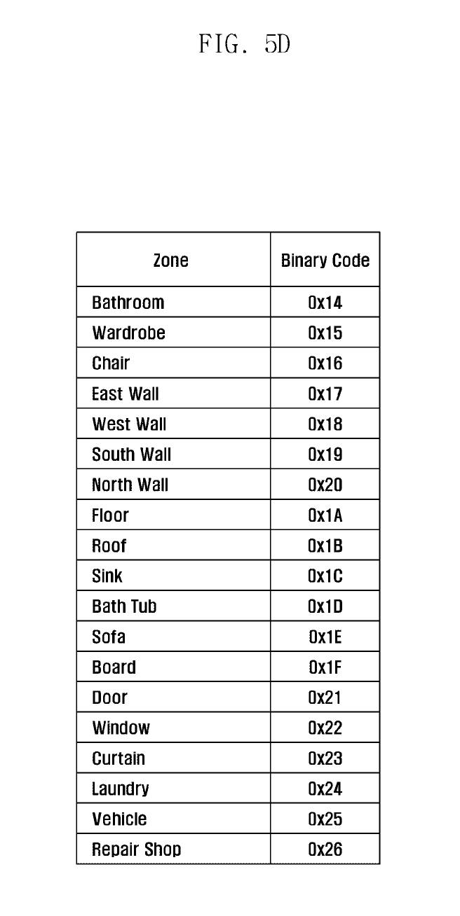

FIG. 4A illustrates a method that the device 405 transmits basic device information periodically to the device information collecting equipment 400. The device 405 broadcasts basic device information to the device information collecting equipment 400 through WLAN communication at step S410. A configuration of a message including basic device information of the device 405 will be described with reference to FIG. 5A.

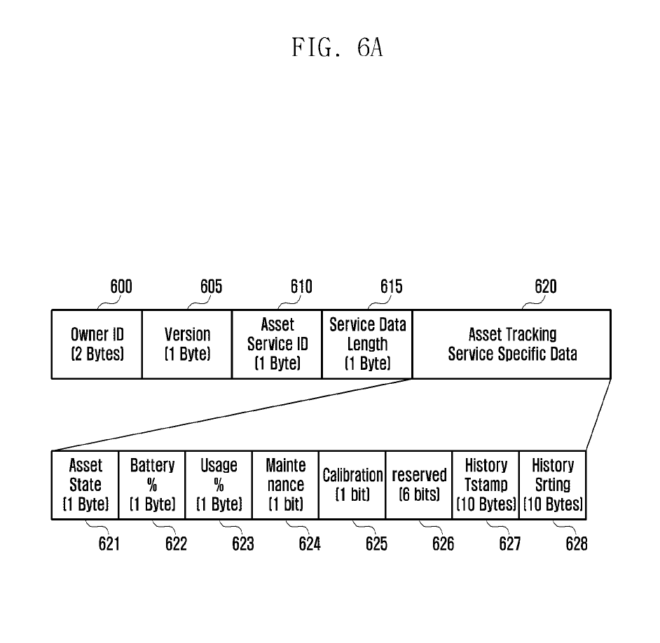

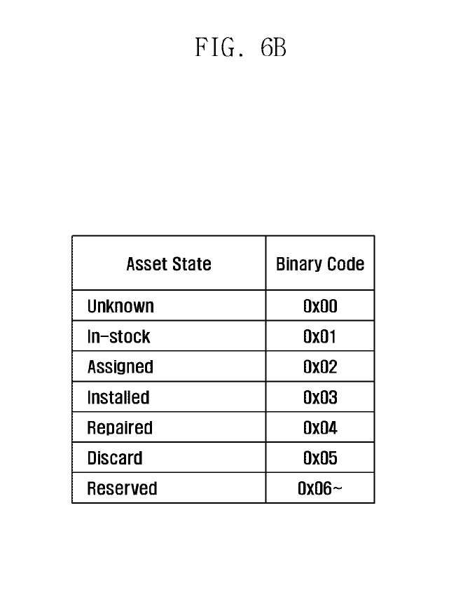

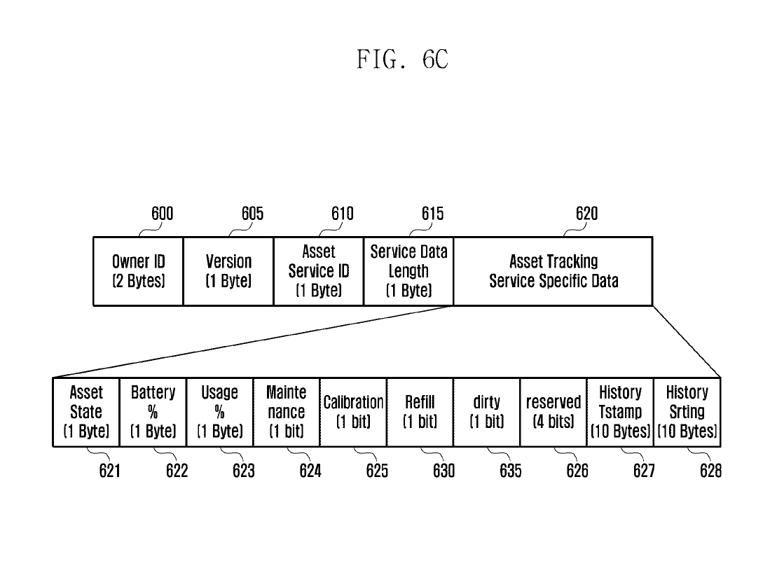

The device information collecting equipment 400 received a notification of the basic device information can determine whether the device state information of the device 405 is necessary to receive. Namely, the necessity of receiving device state information can be determined on the basis of the basic device information. If the reception of the device state information is necessary, the device information collecting equipment 400 transmits a message of requesting device state information to the device which transmitted the notification of basic device information at step S420. The message of requesting device state information may include a scan request message. The scan request message may use a message format defined by Bluetooth standard specifications. The device received the scan request message transmits a device state information response message including device state information to the device information collecting equipment 400 at step S425. The device state information response message may include a scan response message. The device state information response message will be described in more detail with reference to FIG. 6.

Differently from FIG. 4A, FIG. 4B is illustrates a method for notifying basic device information to the device information collecting equipment 400 if the device 405 detects a specific event triggering a notification.

If the basic device information is transmitted by the method shown in FIG. 4A, the device 405 may consume an electric power continuously to transmit basic device information of itself periodically. Devices installed in a guest room may include sensors to which an electric power is not always engaged as well as equipment such as a TV, air conditioner, and lighting to which an electric power is always engaged. Therefore periodical transmission of basic device information may cause an increase of operation costs because the battery replacement period of the devices not always connected to an electric power becomes short. Accordingly, the present disclosure provides a method for transmitting a basic device information message according to generation of a specific event as well as the method for transmitting state information message periodically. Namely, asset equipment does not transmit state information of itself in general situations by switching to a sleep mode and transmits a state information message if a specific event is generated. If the state information message is transmitted for a predetermined time, the asset equipment does not transmit the state information message by returning to the sleep mode.

Hereinafter, a case that the specific event triggering the basic device information is an event related to the device 405 will be described. For example, the event related to the device 405 may include a case that a movement is detected from a fixed device. If a movement is detected through a sensor attached to the device 405, it can be identified that the device 405 may have been damaged or stolen, and the device 405 can transmit a basic device information notification. In this case, the basic device information notification can be transmitted optionally by including information of the movement detection. After receiving the basic device information notification, the gateway or the portable device can collect device state information to transmit to the management server. Further, the device 405 can transmit the basic device information notification while the device 405 continues to move, and if the movement is not detected, the device 405 can stop the transmission of the basic device information notification. Further, if a specific event is not detected, the device 405 can transmit the basic device information notification according to a predetermined notification period.

Hereinafter, a case that the specific event triggering the basic device information notification is related to the device information collecting equipment 400 will be described. For example, if the device information collecting equipment 400 is a portable device, the specific event may include a detection of the portable device entering a guest room. As described in FIG. 3, this may include a case that a door lock or an AP installed in a hotel detects a portable device and transmits information to the device 405 as well as a case that a plurality of devices 300 detects the portable device 310 directly.

The device 405 detects generation of an event triggering the basic device information notification at step S430. The device 405 notifies the basic device information at step S435. Subsequently, the device information collecting equipment 400 requests the device 405 for device state information at step S440, and the device 405 responds to the request for device state information at step S445 in the same method described by steps S420 and S425 of FIG. 4A. Subsequently, if a predetermined period is elapsed, the device 405 transmits the basic device information notification again at step S450.

FIG. 4C illustrates a method for establishing a connection so that the device information collecting equipment 400 changes setting information for the basic device information notification of the device 405. The setting information may include changes of a period of a basic device information notification transmitted by the device 405 and location information of device installation.

In more detail, the device information collecting equipment 400 firstly receives a basic device information notification from the device 405 at step S460. If the basic device information notification is received and the device information collecting equipment 400 determines that a change of setting information of the device 405 is required, the device information collecting equipment 400 requests a connection setting to transmit the setting information at step S470. If information for changing setting information of the basic device information notification is received from the connected management server, the device information collecting equipment 400 can request a connection setting to transmit the setting information. Alternatively, if the device information collecting equipment 400 is a portable device, a manager or a cleaner can input information for changing the setting information directly to the portable device.

The device 405 received a connection request can transmit a connection confirm message to the device information collecting equipment 400. If the connection confirm message is transmitted, a connection can be made between the device 405 and the device information collecting equipment 400 to manage setting information for basic device information notification. Subsequently, the device 405 can transmit the basic device information notification on the basis of settings of the device information collecting equipment 400.

By changing setting information through the connection between the device information collecting equipment 400 and the device 405, a manager or a management system can adjust the period of basic device information notification by considering various situations. For example, the notification period can be set longer for the evening time when the state of the notification period device changes seldom, and a battery consumption of a device can be saved by setting the notification period longer in case that a guest room is empty.

The device 405 can notify the basic device information by using FIGS. 4A, and 4B, and 4C separately, or by combing at least two of them. For example, the device 405 can notify the basic device information with a predetermined period according to FIG. 4A, and at the same time, if a specific even of FIG. 4B is generated, the device 405 can notify the basic device information regardless of the predetermined period. Alternatively, if setting information is received by forming a connection with the device information collecting equipment 400 as shown in FIG. 4C, the basic device information can be notified according to the setting information, and if a specific event of FIG. 4B is generated, the basic device information can be notified regardless of the period determined by the setting information. Therefore the device information can be collected more efficiently by notifying the basic device information to the device information collecting equipment 400 variably.

FIGS. 5A, 5B, 5C, and 5D are diagrams illustrating an example configuration of a basic device information notification message according to an example embodiment.

FIG. 5A illustrates a structure of a basic device information notification message for informing basic device information. For the convenience in description, a header format for transmitting through Bluetooth is omitted here, and the only format corresponding to data payload is described.

The basic device information notification message is configured with an Owner ID field 500 indicating owner of equipment, Version field 505 indicating a version of message, Asset Service ID field 510 indicating a public asset or a personal asset classified by characteristics of a device, and Service Data Length field 515 indicating a length of Asset Tracking Service Specific Data including actual basic device information.

Among these, the Asset Service ID 510 is used for grouping devices according to the characteristics of the devices, for example, by distinguishing an asset owned by a hotel and an asset owned by a guest in a guest room. Here, the management server may manage only the assets owned by the hotel. Accordingly, the device information collecting equipment can filter devices to be asked for device state information on the basis of the Asset Service ID field 510.

In order to indicate the basic device information, the asset tracking service specific data is further configured with an Asset Type 521, Asset ID 523, Location ID 525, Zone ID 527, and Sub-Zone ID 529 fields. The asset type field is used for distinguishing a device type and may be indicated in the form shown in FIG. 5B. The Asset ID field is a field for distinguishing equipment having an identical Asset Type and each device has an intrinsic ID.

The Location ID field is a field for indicating locations of installed assets such as a lobby, fitness center, swimming pool, and guest room, and FIG. 5C and 5D illustrate examples usable for the location ID field. The Zone ID field is a field used for dividing a location into smaller sections such as a bedroom, toilet, living room included in a guest room. Additionally, the Sub-Zone ID field can be defined to indicate a more detailed section. For example, a northern wall of a bedroom can be used as a value for the Sub-Zone ID field.

FIGS. 6A, 6B, and 6C are diagrams illustrating an example configuration of a device state information notification message according to an example embodiment.

FIG. 6A illustrates a structure of a device state information response message for a device to transmit device state information of itself to the information collecting equipment. The device state information response message has the same structure as the basic device information notification message shown in FIG. 5. Namely, Owner ID 600, Version 605, Asset Service ID 610, Service Data Length 615 fields are same as those of FIG. 5, however the Asset Tracking Service Specific Data 620 indicating device state information has a different structure.

The Asset Tracking Service Specific Data of the device state information response message may include an Asset state 621 for indicating device state information, Battery % 622 for indicating an available battery amount, usage % 623 for indicating usage of a memory and a processor, maintenance flag 624 for notifying necessity of repair and check, and Calibration flag 625 for notifying necessity of calibration or resetting of a measuring sensor. Further, a History Tstamp field 627 for indicating a transmission time of a recent device state information response message and History string 628 field for indicting information in the device state information response message may be further included.

Here, in order to request a state check by using the Maintenance flag 624, a device must recognize itself that an abnormal state has been generated. Various technologies can be used for the recognition of the abnormal state, however descriptions on these technologies will be omitted because the related technologies are out of the scope of the present disclosure. In order to set the Calibration flag 625, the device can predetermine periods of compensation and resetting and request for compensation periodically. Further, in case of a device including a sensor module, if a difference between the currently measured value and values previously measured and stored in history information is great, the device can identify and display the necessity of compensation in the Calibration flag 625.

The Asset state field 621 can be input and predetermined by a manager according to a device state. FIG. 6B illustrates states which can be included in the Asset state field 621. For example, the states may include “In-stock” indicating that a device is not being used and kept in a stock, “Assigned” indicting that a device is scheduled to install at a specific location, “Installed” indicating that a device has been installed at a specific location, “Repaired” indicating that a device has been recovered from an abnormal state, and “Discarded” indicating that a device has been discarded or removed from an installation location.

FIG. 6B illustrates a device state response message transmitted by a device according to further another embodiment.

Besides general devices such as a TV, electric stand, and telephone, a method for managing and replacing devices or materials everyday such as a towel, shampoo, and soap will be described hereinafter. In more detail, FIG. 6C is almost identical to FIG. 6A, however Refill field 630 and Dirty field 635 are included in the Asset Tracking Service Specific Data 620.

For example, a guest may experience inconveniences because the guest has to ask a service if a shampoo or a soap is used up while staying in a room. In order to avoid such inconveniences, device information can be collected by attaching a sensor, LAN communication module, or RFID to the devices or materials requiring an everyday check.

If it is identified that an available amount of a material included in a device has been reduced to a critical value, the fact can be transmitted by including in the Refill field 630. Alternatively, if a guest desires to replace bedclothes, the guest can add intention of replacing the bedclothes into the Dirty field 635.

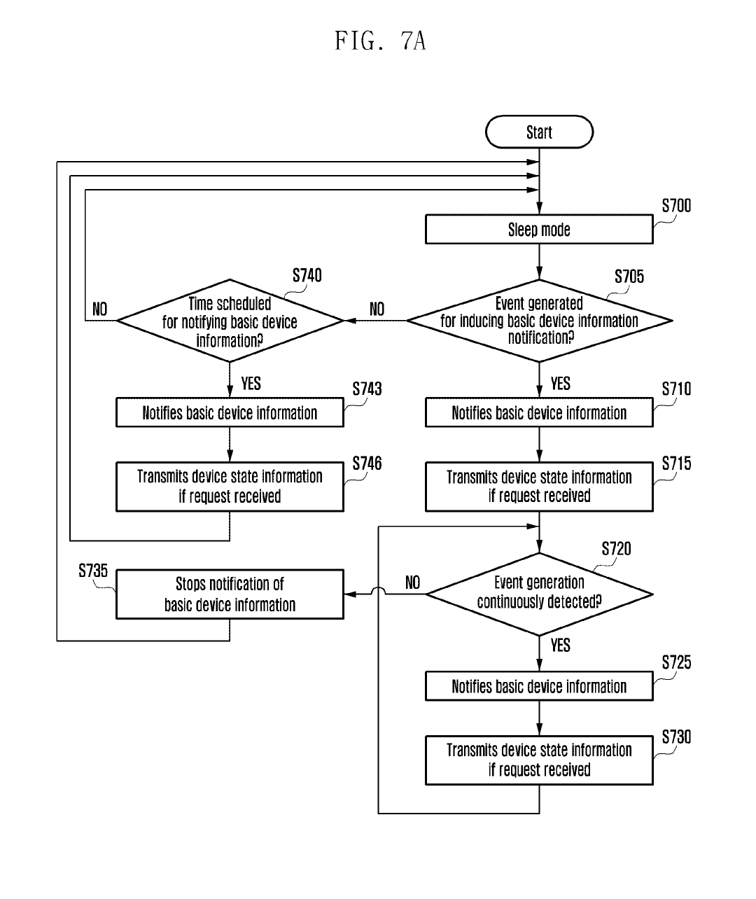

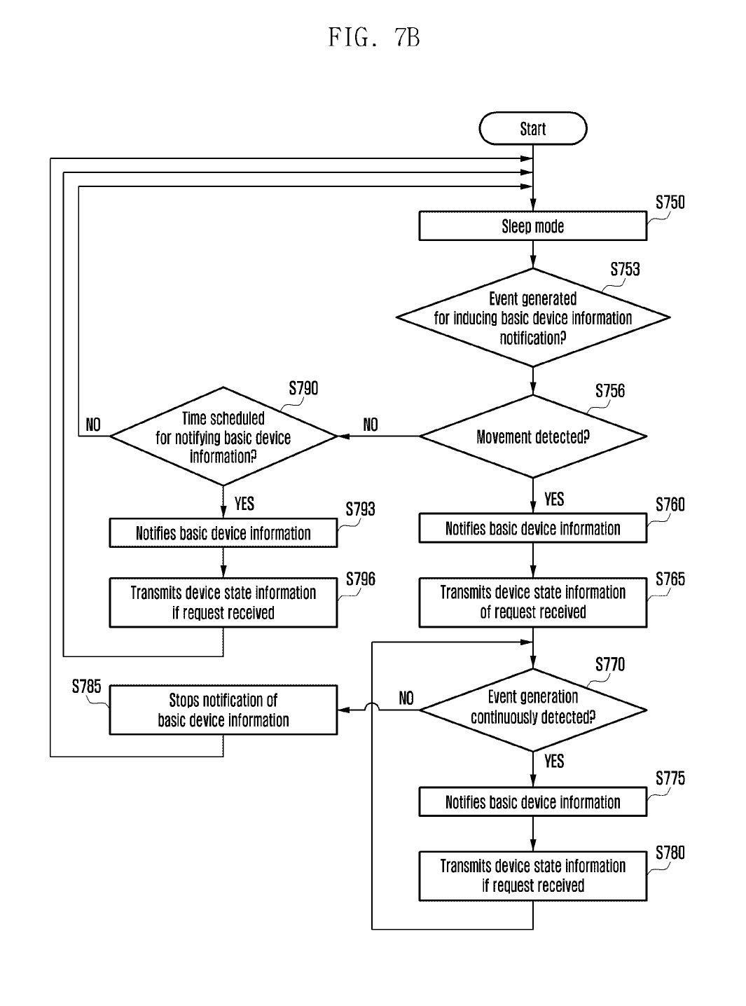

FIGS. 7A and 7B are flowcharts illustrating example operations of a device according to an example embodiment.

FIG. 7A is a flowchart illustrating an example procedure of operating a device according to the first method in case that the information collecting equipment is a gateway installed in an indoor space, and FIG. 7B is a flowchart illustrating an example procedure of operating a device according to the second method in case that the information collecting equipment is a portable device. In particular, FIGS. 7A and 7B are flowcharts illustrating an example procedure of operating a device according to an example embodiment combining the procedures of FIGS. 4A and 4B.

In FIG. 7A, the device is basically in a sleep mode as shown by step S700. Subsequently, the device identifies whether an event triggering a basic device information notification is generated at step S705. The event triggering a basic device information notification is an event related to the device as described above, and may include a case that a movement is detected from a fixed device. Subsequently, if an event triggering a basic device information notification is generated, the device notifies basic device information to the gateway at step S710. The notification of the basic device information can be performed by transmitting the basic device information message through WLAN communication including Bluetooth communication. Subsequently, if a request for device state information is received from the device information collecting equipment, the device transmits the device state information to the device information collecting equipment at step S715.

The device identifies whether the event generated at step S720 is continuously detected at step S720. If the generation of event is continuously detected, the device continues to notify the basic device information at step S725 similarly to step S710. Subsequently, if a request for device state information is received from the device information collecting equipment, the device state information is transmitted to the device information collecting equipment at step S730.

If the generation of event is not continuously detected at step S720, the device stops to transmit the basic device information notification at step S735. Subsequently, the device enter a sleep mode by returning to step S700.

If the generation of event is not detected at step S720, the device identifies whether the current time is scheduled to notify basic device information at step S740. If the current time is not scheduled to notify basic device information, the device enter a sleep mode by returning to step S700.

If the current time is scheduled to notify basic device information, the device notifies basic device information at step S743. Subsequently, if a request for basic device information is received, the device state information is transmitted to the device information collecting equipment at step S746. Subsequently, the device enter a sleep mode by returning to step S700.

The flowchart hays been illustrated as an embodiment of the present disclosure, however the sequence of steps can be differently configured as long as achieving the object of the present disclosure.

In FIG. 7B, the device is basically in a sleep mode as shown by step S750. Subsequently, the device identifies whether a portable device for collecting device information is detected at step S753. As already described in FIG. 4B, this may include a case that a door lock or an AP installed in a hotel detects a portable device and transmits information to the device 405 as well as a case that a plurality of devices 300 detects the portable device 310 directly.

Subsequently, the device identifies whether an event triggering a basic device information notification is generated at step S756. This step is same as the step S705. If an event triggering a basic device information notification is generated, the device notifies basic device information at step S760. Subsequently, if a request for device state information is received from the device information collecting equipment, the device transmits device state information to the device information collecting equipment at step S765.

Further, the device identifies whether the generation of event identified at step S755 is continuously detected at step S770. If the generation of event is continued, the device continues to notify basic device information at step S775 in the same manner as step S760. Subsequently, if a request for device state information is received from the device information collecting equipment, the device state information is transmitted to the device information collecting equipment at step S780.

If the generation of event is not continuously detected at step S770, the device stops to transmit basic device information notification at step S785. Subsequently, the device enter a sleep mode by returning to step S750.

If the generation of event is not detected at step S755, the device identifies whether the current time is scheduled to notify basic device information at step S790. If the current time is not scheduled to notify basic device information, the device enter a sleep mode by returning to step S750.

If the current time is scheduled to notify basic device information, the device notifies basic device information at step S793. Subsequently, if a request for basic device information is received, the device state information is transmitted to the device information collecting equipment at step S796. Subsequently, the device enter a sleep mode by returning to step S750.

The flowchart has been illustrated as an embodiment of the present disclosure, however the sequence of steps can be differently configured as long as achieving the object of the present disclosure. In case of using the method of FIG. 7B, device information can be collected by using a portable device having a WLAN communication function even though a separate gateway is not installed indoors.

FIG. 8 is a schematic drawing illustrating example communication equipment attached to a device according to an example embodiment.

Hereinabove, descriptions have been made for devices supporting a WLAN function, however a method for managing legacy devices having no WLAN function is provided with reference to FIG. 8. In the present disclosure, detachable WLAN communication equipment has been designed to manage devices. This equipment is a small one designed for asset management in a guest room and may called Asset tag 800. FIG. 8 illustrates a shape of the tag 800 and a method of attaching and detaching the tag 800.

The tag is a small equipment not using an electric power and attachable to any device. The tag may be configured in a detachable type or an adhesive type. According to the object of the present disclosure, all the types of communication equipment capable of transmitting device information can be included. Namely, the tag 800 can provide device state information instead of transmitting device state information directly by a device. The tag may include a wireless communication module, acceleration sensor, information notification scheduler, and maintenance button, which can provide device information for a gateway or a portable device. Device information collecting equipment transmitting and receiving information by pairing with such as tag can be called hub device.

The tag can basically provide information of existence, location, movement, or fall down state of a device. Further, the tag may include a maintenance button which can be used to inform a manager if a user of facilities decides that repair or maintenance is necessary.

In order to transmit device state information to the hub device, the tag 800 may use the method described in FIGS. 4A, 4B, and 4C. Namely, the tag 800 can transmit basic device information in a predetermined period before transmitting device state information, or transmit the basic device information to the hub device if a specific even triggering a device state information notification is detected. If the hub device received basic device information determines that collection of device information is necessary, the hub device can request device state information and receive a device state response message correspondingly. Further, as described in FIG. 4C, the hub device can establish a connection with the tag 800 in order to set a basic device information notification.

Hereinafter, a detailed embodiment of providing device state information by attaching a tag will be described. The tag 800 can provide device state information by including various kinds of sensors. The following information can be transmitted or stored by adding to the data format described in FIG. 6A.

For example, if a tag is attached home appliances such as an electric stand 810, TV 820, and refrigerator 830 and the tag measures a temperature higher than a critical temperature by measuring a heat dissipation through a temperature sensor, a warning message can be transmitted. Further, if a tag is attached to an electrical socket 840, an electrical short can be identified and a warning message can be transmitted. Further, if a tag is attached to a device or a material such as a shampoo bottle 850 which should be refilled or replaced daily, the tag takes a role of a sensor and measures a residual amount in the bottle to inform necessity of refill as described in FIG. 6C.

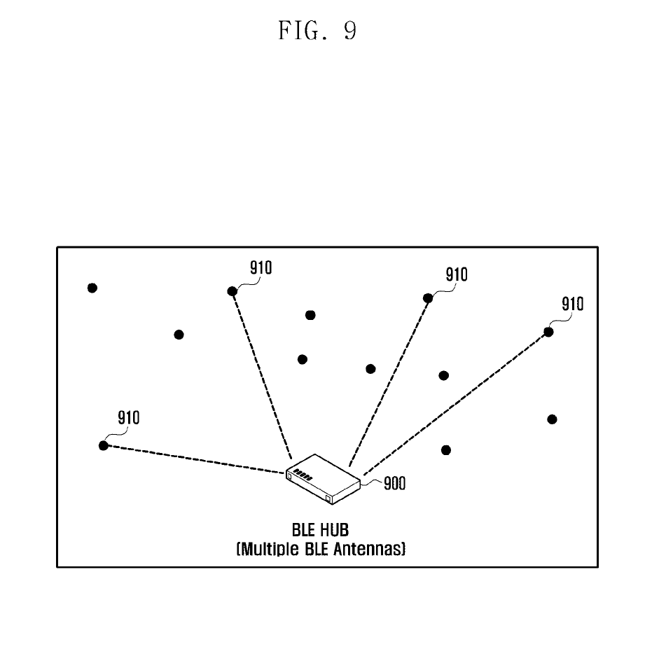

FIG. 9 is a schematic drawing illustrating an example hub device connected to a communication equipment attached to a device for collecting location information of the communication equipment according to an example embodiment.

FIG. 9 illustrates a hub device 900 and a tag 910, however this embodiment can be also applied between a gateway and a device. The hub device 900 can measure a location of the tag 910 by using a location determining method such as an RSSI (Received Signal Strength Indicator) method or an AOA (Angle of Arrival) method. If the measured location is identified to change by comparing with previously measured locations, the hub device 900 can set the changed location information by using a connection already established with the tag 910. Like this, the hub device can modify the location information by identifying a movement of a device through the established connection, and thereby inconveniences of changing the location manually can be resolved when a user or a manager moves a device to another location.

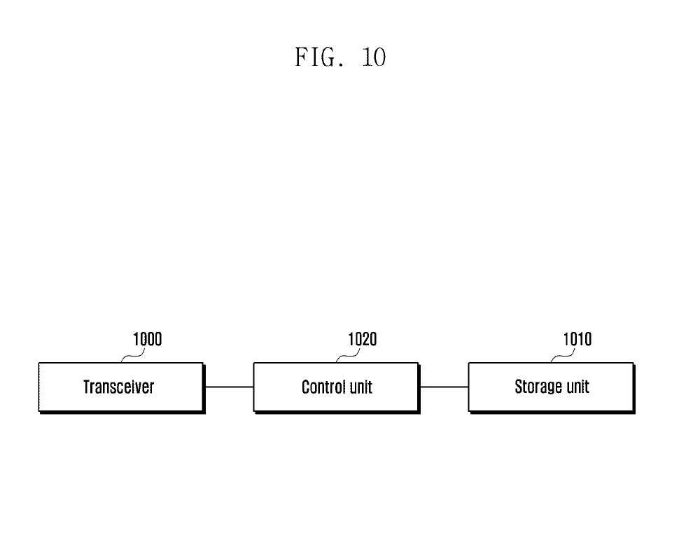

FIG. 10 is a block diagram illustrating an internal configuration of device information collecting equipment according to an embodiment.

With reference to FIG. 10, the information collecting equipment may include a communication unit (e.g., including communication circuitry) 1000, storage unit 1010, and control unit (e.g., including a controller) 1020. The information collecting equipment may include at least one of a gateway and a portable terminal as described before.

The communication unit 1000 can transmit and receive information required for operating the information collecting equipment. Further, the communication unit 1000 can transmit and receive information using various communication circuitry, such as, for example, and without limitation, WLAN communication such as a Bluetooth. In more detail, the communication unit 1000 may include various communication circuitry that can receive basic device information from at least one indoor device. The basic device information can be transmitted by using a broadcasting method. Further, the communication unit 1000 can request at least one indoor device for device state information. Further, the communication unit 1000 can receive device state information from at least one indoor device. Further, the communication unit 1000 can transmit to and receive from communication equipment attached to the indoor device. Further, the communication unit 1000 can transmit information received from the at least one device or the communication equipment attached to a device to a management server through a wired connection.

The storage unit 1010 can store information required for operating the information collecting equipment. The storage unit 1010 can store information received from the communication unit 1000.

The control unit 1020 may include, for example, and without limitation, a controller configured to determine at least one device to be requested for device state information on the basis of basic device information received from the at least one device, to request device state information to the determined at least one device, and to transmit the device state information to a management server by receiving from the determined at least one device.

Further, the control unit 1020 may be configured to request device state information to a device whose service type information is a public asset. The control unit 1020 requests establishment of a connection to the determined at least one device, and can control to change setting information for the transmission of the basic device information if the connection is established.

The control unit 1020 may be configured to determine at least one device to be requested for device state information on the basis of basic device information received from communication equipment attached to the at least one device, to request device state information to the communication equipment attached to the determined at least one device, and to transmit the device state information to a management server by receiving from the communication equipment attached to the determined at least one device.

The control unit 1020 may be configured to request device state information to the device whose service type information is a public asset. Further, the control unit 1020 may be configured to request establishment of a connection to the communication equipment attached to the determined at least one device, and to change setting information for the transmission of the basic device information if the connection is established.

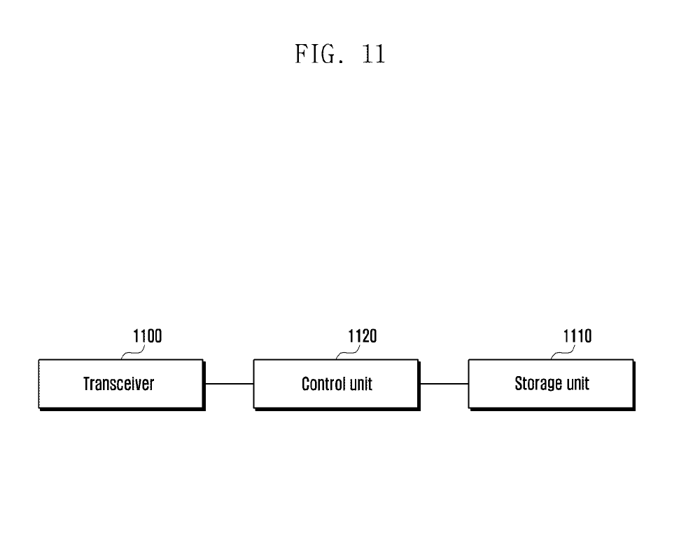

FIG. 11 is a block diagram illustrating an example internal configuration of communication equipment attached to a device according to another example embodiment.

With reference to FIG. 11, the indoor device may include a communication unit (e.g., including communication circuitry) 1100, storage unit 1110, and control unit (e.g., including a controller) 1120.

The communication unit 1100 may use various communication circuitry transmit and receive information so that the indoor device operates according to the present disclosure. In more detail, the communication unit 1100 can transmit basic device information and receive a request for device state information from the information collecting equipment. If the request for device state information is received, the device state information can be transmitted to the information collecting equipment in response.

The storage unit 1110 can store information so that the indoor device operates according to the present disclosure. In more detail, the storage unit 1110 can store information transmitted or received by the communication unit 1100. Further the storage unit 1110 can provide the information for the control unit 1120.

If a terminal entering indoors is detected, the control unit 1120 may, for example, and without limitation, include a controller configured to transmit basic device information to the terminal, to transmit device state information to the terminal if a request for the device state information is received, and to transmit the device state information from the terminal to a management server.

Further, the control unit 1120 may be configured to transmit the basic device information to the terminal after detecting the terminal entering an indoor space, if a movement of a device is detected, or if a predetermined transmission period is elapsed.

Further, the control unit 1120 may be configured to receive a request for establishment of a connection from the terminal, and to change setting information for transmitting the basic device information by receiving information for changing the setting information if the connection is established.

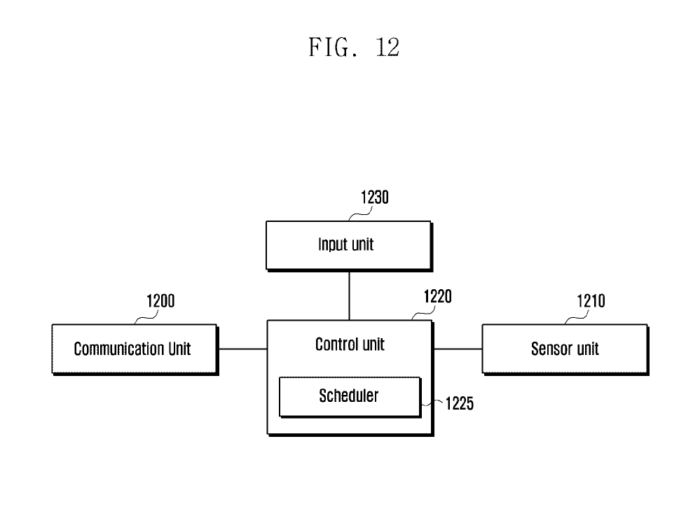

FIG. 12 is a block diagram illustrating an example internal configuration of a device according to another example embodiment.

With reference to FIG. 12, the communication equipment attached to a device may include a communication unit (e.g., including communication circuitry) 1200, sensor unit 1210, control unit (e.g., including a controller) 1220, and input unit (e.g., including input circuitry) 1230. Further, the control unit 1220 may include a scheduler.

The communication unit 1100 may include, for example, various communication circuitry and can transmit and receive information so that the communication equipment attached to the device operates according to the present disclosure. In more detail, the communication unit 1100 can transmit basic device information to the information collecting equipment and receive device state information from the information collecting equipment. If the request for the device state information is received, the device state information can be transmitted to the information collecting equipment in response. The communication unit 1100 can transmit and receive the information by using various communication circuitry, such as, for example, and without limitation, a WLAN communication such as Bluetooth communication. The sensor unit 1210 can obtain information for generating device state information. In more detail, the sensor unit 1210 may include an acceleration sensor, movement sensor, and gravity sensor. Further, the sensor unit 1210 may include a temperature detecting sensor, electric current detecting sensor, and contact sensor. The sensor unit 1210 can transmit information from the devices to the control unit 1220.

The input unit 1230 may be attached to a button part of the communication equipment attached to the device to receive information input by a user. The button part may include a maintenance request button, and if a user input is detected, information of requesting maintenance can be transmitted to the control unit 1220.

The control unit 1220 may be configured to transmit basic device information to the information collecting equipment, to generate the device state information if a request for device state information is received from the information collecting equipment, to transmit the device state information to the information collecting equipment, and to transmit the device state information to a management server from a terminal.

If information of a maintenance request is received by a user input, the control unit 1220 can be configured to transmit the device state information to the information collecting device by including information required for maintenance. Further, if the request for device information is received, the control unit 1220 may be configured to measure states of the indoor device and to generate the device state information on the basis of the measured device state.

The control unit 1220 can be configured to transmit the basic device information to the information collecting device after detecting the terminal entering indoors, if a movement of a device is detected, or if a predetermined transmission period is elapsed.

The control unit 1220 can be configured to receive a request for establishment of a connection from the information collecting equipment, and to change setting information for transmitting the basic device information by receiving information for changing the setting information if the connection is established.

A method and a device according to embodiments of the present disclosure can improve conveniences in managing indoor devices by collecting device state information from at least one indoor device and transmitting the information to a management server. Further, by using communication equipment attached to an indoor device, state information of an indoor device having no communication function can be collected, and thereby the indoor devices can be totally managed regardless of the types of devices.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for managing indoor information in a terminal, the method comprising:
determining at least one device from which to request device state information based on basic device information received from at least one device;
requesting device state information from the determined at least one device; and
transmitting the device state information to a management server from the determined at least one device;
wherein the basic device information is transmitted if the terminal being indoors is detected .

2. The method of claim 1,
wherein the basic device information comprises at least one of service type information, device type information, ID (Identification) information, and a location of the device, and
wherein the basic device information is transmitted after the terminal being indoors is detected, if a movement of the device is detected, or if a predetermined transmission period is reached.

3. A method for managing indoor device information in information collecting equipment, the method comprising:
determining at least one device from which to request device state information based on basic device information received from communication equipment attached to at least one device;
requesting device state information from the communication equipment attached to the determined at least one device; and
transmitting the device state information to a management server from the communication equipment attached to the determined at least one device.

4. The method of claim 3,
wherein the device state information comprises information of maintenance necessity input to the communication equipment attached to the device, and
wherein the device state information is based on information detected by the communication equipment attached to the device.

5. The method of claim 3, further comprising:
requesting the determined at least one device for establishment of a connection; and
changing setting information for transmitting the basic device information if the connection is established.

6. A method for supporting device information management in an indoor device, the method comprising:
transmitting basic device information to a terminal if the terminal being indoors is detected; and
transmitting device state information to the terminal if a request for device state information is received from the terminal;
wherein the device state information is transmitted to a management server from the terminal.

7. The method of claim 6, further comprising:
receiving a request for establishment of a connection from the terminal; and
changing setting information for transmitting the basic device information received from the terminal if the connection is established.

8. A method for supporting device information management in a communication equipment attached to an indoor device, the method comprising:
transmitting basic device information to information collecting equipment;
generating device state information if a request for device state information is received from the information collecting equipment; and
transmitting the device state information to the information collecting equipment;
wherein the device state information is transmitted to a management server from a terminal.

9. The method of claim 8,
wherein the information collecting equipment comprises a portable terminal,
wherein the basic device information is transmitted if the portable terminal being indoors is detected, and
wherein transmitting basic device information to information collecting equipment is performed by transmitting the basic device information after the terminal being indoors is detected, if a movement of the device is detected or a predetermined transmission period is reached.

10. The method of claim 8, further comprising:
measuring a state of the indoor device if the request for device state information is received; and
generating device state information based on the measured device state.

11. A terminal for managing indoor device information, the terminal comprising:
a transceiver configured to transmit and receive information; and
a controller configured to determine at least one device from which to request device state information based on basic device information received from the at least one device, to request device state information from the determined at least one device, and to transmit the device state information to a management server from the determined at least one device;
wherein the basic device information is transmitted if the terminal being indoors is detected .

12. The terminal of claim 11, wherein the basic device information comprises at least one of service type information, device type information, ID (Identification), and location of the device, and
wherein the controller is further configured to request device state information from a device whose service type information is a public asset.

13. An information collecting equipment for managing indoor device information, the equipment comprising:
a transceiver configured to transmit and receive information; and
a controller configured to determine at least one device from which to request device state information based on basic device information received from a communication equipment attached to the at least one device, to request device state information from the communication equipment attached to the determined at least one device, and to transmit the device state information to a management server from the communication equipment attached to the determined at least one device.

14. The information collecting equipment of claim 13,
wherein the information collecting equipment comprises a portable terminal, and
wherein the basic device information is transmitted if the portable terminal being indoors is detected.

15. The information collecting equipment of claim 13, wherein the basic device information comprises at least one of service type information, device type information, ID (Identification), and location of the device, and
wherein the controller is configured to request device state information from a device whose service type information is a public asset.

16. An indoor device for supporting a device information management, the device comprising:
a transceiver configured to transmit and receive information; and
a controller configured to transmit basic device information to a terminal if the terminal being indoors is detected, to transmit device state information to the terminal if a request for the device state information is received from the terminal, and to transmit the device state information to a management server from the terminal.

17. The indoor device of claim 16,
wherein the basic device information comprises at least one of service type information, device type information, ID (Identification), and location of the device, and
wherein, if a movement of the device is detected, or if a predetermined transmission period is reached, the basic device information is transmitted to the terminal after the terminal being indoors is detected.

18. A communication equipment attached to an indoor device for supporting device information management, the communication equipment comprising:
a transceiver configured to transmit and receive information; and
a controller configured to transmit basic device information to an information collecting equipment, to generate the device state information if a request for device state information is received from the information collecting equipment, to transmit the device state information to the information collecting equipment, and to transmit the device state information to a management server from a terminal.

19. The communication equipment of claim 18, wherein the controller is configured to transmit the device state information to the information collecting device including information of maintenance necessity if an input for requesting maintenance is received, and
wherein the controller is further configured to measure a state of the indoor device if a request for device state information is received, and to generate the device state information based on the measured device state.

20. The communication equipment of claim 18,
wherein the basic device information comprises at least one of service type information, device type information, ID (Identification), and location of the device,
wherein the controller is further configured to receive a request for establishing a connection from the information collecting equipment, and to change setting information for transmitting the basic device information received from the information collecting equipment if the connection is established.
